(19) United States
(12) Patent Application Publication
(10) Pub. No.: US 2004/0099472 A1
(43) Pub. Date: May 27, 2004

(54) Ball-screw assembly having an isolator member

(76) Inventors: Oliver G. Johnson, Saginaw, MI (US); Eric D. Pattok, Saginaw, MI (US); Rolf E. Kleinau, Bay City, MI (US)

Correspondence Address: CHARLES K. VEENSTRA, DELPHI TECHNOLOGIES, INC., Intl Prop - Legal Staff, M/C 480-410-202, P.O. Box 5052, Troy, MI, 48007, US

(21) Appl. No.: 10/302,170

(22) Filed: Nov. 22, 2002

(51) Int. Cl. B62D 5/04

(52) U.S. Cl. 180/444

(57) ABSTRACT

A ball-screw assembly comprising a ball-nut, a ball screw, a shell assembly, and an isolator member. The ball-nut threadingly engages the ball screw such that rotation of the ball-nut causes the rack shaft to move in a linear direction or vice versa. The shell assembly defines a cavity having the ball-nut disposed therein. The isolator member is disposed between the shell assembly and the ball-nut and transmits rotational forces between the shell assembly and the ball-nut. The isolator member acts as a spherical joint to allow the ball-nut and the ball screw to pivot within the shell assembly about a point on an axis of the ball screw, without causing the shell assembly to move.

### CROSS REFERENCE TO RELATED APPLICATIONS

This application is related to commonly owned and assigned U.S. patent application Ser. No. 09/895,821 filed on Jun. 29, 2001, the contents of which are incorporated herein in their entirety.

### BACKGROUND

Vehicles require a steering system to control the direction of travel. Previously, mechanical steering systems have been used. Mechanical steering systems include a mechanical linkage between a steering input device such as a steering or hand wheel and a steerable output device, such as the road wheels of the vehicle. Thus, movement of the steering input device causes a corresponding movement of the steering output device.

Mechanical steering systems are being replaced and/or supplemented by electrically driven steering systems. Such systems can replace, to varying extents, the mechanical linkage between the steering input device and the steering output device with, for example, an electrically actuated system. Alternately, such systems can assist, to varying extents, the operator's movement of the steering output device with, for example, an electrically assisted steering system.

Some electrically actuated or electrically assisted steering systems can comprise a steering rack operatively coupled to the steering output device by an articulated mechanical linkage. The articulated mechanical linkage is configured to translate linear movement of the rack into the desired movement of the steering output device. An electric motor can induce or assist the linear movement of the rack. For example, the linear movement of the rack can be induced by the electric motor in so called steer-by-wire systems. Alternately or in addition, a pinion gear can operatively couple the hand wheel to the rack so that rotation of the hand wheel causes the rack to move linearly. This liner movement can be assisted by the electric motor (e.g., an electrically assisted steering system).

To connect the electric motor to the rack, ball screw mechanisms have been employed. Ball-screw mechanisms comprise a ball-nut and a ball-screw portion formed on the rack shaft. The motor is configured to impart a rotational force on the ball-nut to cause the ball-nut to rotate. The ball-nut threadingly engages the ball-screw portion defined on the rack shaft. Rotation of the ball-nut by the motor causes the threaded engagement of the ball-nut and ball-screw to move the rack in a linear direction.

The ball-screw assembly can experience loads and forces that can affect its cost, efficiency, and reliability. For example, loads and forces can be transmitted by the rack to the ball-screw assembly from the road wheels as they travel along the road surface. Additionally, the forces on the motor are transmitted to the ball-screw assembly.

Accordingly, there is a continuing need for ball-screw assemblies configured to operate in the desired environment, yet having a low cost, high efficiency, and high reliability.

### SUMMARY

A ball-screw assembly comprising a ball-nut, a ball screw, a shell assembly, and an isolator member is provided. The ball-nut threadably engages the ball screw such that rotation of the ball-nut causes the rack shaft to move in a linear direction or vice versa. The shell assembly defines a cavity having the ball-nut disposed therein. The isolator member is disposed between the shell assembly and the ball-nut to transmit rotational forces between the shell assembly and the ball-nut. The isolator member acts as a spherical joint to allow the ball-nut and the ball screw to pivot within the shell assembly about a point on an axis of the ball screw, without causing the shell assembly to move.

The above-described and other features are appreciated and understood by those skilled in the art from the following detailed description, drawings, and appended claims.

### DESCRIPTION OF THE DRAWINGS

FIG. 1 is an illustration of an electrically assisted steering system for a vehicle;

FIG. 2 is an illustration of a portion of the system of FIG. 1;

FIG. 3 is a side view of an exemplary embodiment of a ball-screw assembly;

FIG. 4 is a sectional view of the assembly of FIG. 3 taken along lines 4-4;

FIG. 5 is a side view of an exemplary embodiment of an isolator member; and

FIG. 6 is a sectional view of the isolator member of FIG. 5 taken along lines 6-6.

### DETAILED DESCRIPTION

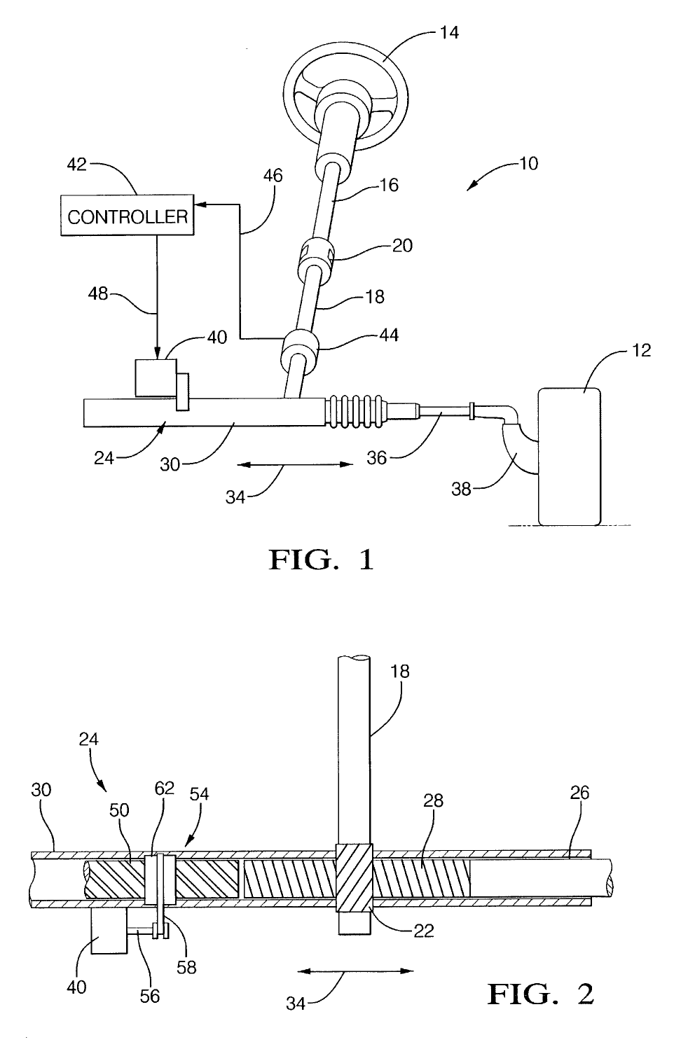

Referring now to the figures, and in particular to FIGS. 1-2, an electrically assisted steering system 10 for use in a vehicle (not shown) is illustrated. Steering system 10 allows the operator of the vehicle to control the direction of the steerable road wheels 12 (only one shown) through the manipulation of a hand wheel 14.

Steering system 10 comprises a first steering shaft 16 and a second steering shaft 18. Hand wheel 14 is positioned at a first end of the first steering shaft 16 so that the operator can apply a rotational force to the first steering shaft. A universal joint 20 is connected to first steering shaft 16 opposite the hand wheel. Joint 20 couples first steering shaft 16 to an end of second steering shaft 18 such that rotation of the first steering shaft causes the second steering shaft to rotate.

The second steering shaft 18 comprises a pinion gear 22 disposed opposite the universal joint 20. Pinion gear 22 is meshingly engaged with a rack assembly 24. Rack assembly 24 comprises a rack shaft 26 having a toothed portion 28. Pinion gear 22 meshingly engages toothed portion 28 to form a rack and pinion gear set. Rack assembly 24 can further comprise a housing 30 secured to a portion of the vehicle, such as a vehicle frame (not shown).

Rotation of hand wheel 14 is transmitted by first and second shafts 16 and 18 to rack assembly 24, which converts this rotation into a linear movement of rack shaft 26 in the direction of arrow 34. The movement of rack shaft 26 causes the rack shaft to slide within housing 30. The ends of rack shaft 26 are coupled to road wheels 12 through tie rods 36 (only one shown) and knuckles 38 (only one shown). The movement of rack shaft 26 in the direction of arrow 34 causes tie rods and knuckles 36 and 38 to steer the road wheels 12 in a known manner.

A motor 40 is configured to assist the operator in the movement of rack shaft 26. Motor 40 is in electrical communication with a controller 42. Controller 42 is in electrical communication with sensor(s) 44. Sensor(s) 44 provide input(s) 46 to controller 42 indicative of the movement of hand wheel 14. For example, sensor(s) 44 can include position sensors, torque sensors, and combinations thereof. Controller 42 is configured to provide an output signal 48 in response to inputs 46 and possibly other inputs (not shown) to activate the motor 40 and assist in the movement of rack shaft 26.

Rack shaft 26 may also comprise a threaded ball-screw portion 50, which is threaded to ball-nut 52. Ball-nut 52 is rotatably supported in housing 30. Ball-screw portion 50 and ball-nut 52 form a ball-screw assembly 54.

Motor 40 is configured to rotate a motor shaft 56, which drives a belt 58. In one embodiment, belt 58 is a timing belt and engages teeth (not shown) on an exterior surface of shell assembly 62 of ball-screw assembly 54. A timing belt provides a positive, slip free connection between motor shaft 56 and shell assembly 62. The rotation of shell assembly 62 causes ball-screw assembly 54 to move rack shaft 26 in the direction of arrow 34 as will be hereinafter described. When the operator of the vehicle turns hand wheel 14, sensor(s) 44 provide input(s) 46 to controller 42. Controller 42 energizes motor 40 to assist in the movement of rack shaft 26, and thus to assist in the steering of road wheels 12.

It should be noted that steering system 10 is described herein by way of example only as an electrically assisted steering system for use in an over the road vehicle. Of course, it is contemplated for steering system 10 to include electrically assisted steering systems for use with vehicles, such as but not limited to, marine vehicles, all terrain vehicles, snow mobiles, and the like. Additionally, it is contemplated for steering system 10 to include electrically actuated steering systems (e.g., steer-by-wire steering systems). Here, the steering system would not include the second steering shaft 18 such that the motor moves the rack assembly in the desired direction.

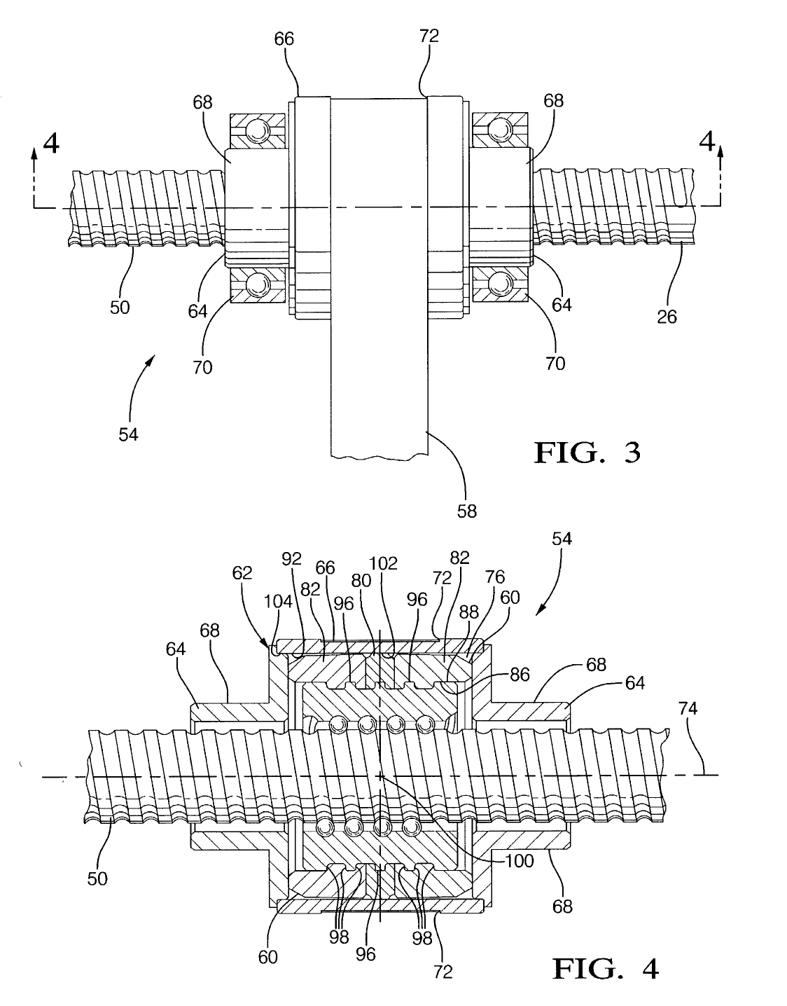

In addition, it should be recognized that ball-screw assembly 54 is described by way of example only. For example, the assembly is described as having rotational forces being transferred from motor 40 to the assembly by belt 58. Of course, belt 58 can be replaced by a chain, a gear, or other means for rotating ball-nut 52. For example, ball-nut 52 can form a rotor portion of motor 40. Turning now to FIGS. 2-4, an exemplary embodiment of ball-screw assembly 54 is illustrated. Assembly 54 comprises ball-nut 52, an isolator member 60, and a shell assembly 62.

Shell assembly 62 comprises a pair of end caps 64 and a pulley portion 66. End caps 64 each include a support surface 68. The shell assembly is rotatably supported within housing 30 (FIGS. 1, 2) by bearings 70, which are disposed on support surfaces 68 of caps 64. An exterior of pulley portion 66 is configured to be frictionally engaged with belt 58. For example, pulley portion 66 can include a recess 72 configured to receive belt 58. In this manner, shell assembly 62 can be rotated within housing 30 about an axis 74 of rack shaft 26 by motor 40 (FIG. 1).

Shell assembly 62 may be constructed out of any type of material, including a ferrous material, a plastic material, a composite material, or a metal alloy material. In an exemplary embodiment, the shell assembly is formed of an aluminum alloy material, which allows the overall mass and inertia of steering system 10 to be minimized.

Shell assembly 62 defines a cavity 76 configured to receive ball-nut 52 and isolator member 60. In alternate embodiments, cavity 76 may be cylindrical as shown, i.e., having a circular cross section, or have other cross-sectional shapes, including for example, hexagonal, or octagonal. Alternatively, cavity 76 may be fluted or otherwise formed to enhance engagement with isolator member 60 as described in further detail below. Ball-nut 52 is engaged with threaded portion 50 of rack shaft 26. Isolator member 60 supports and surrounds ball-nut 52 within shell assembly 62. Isolator member 60 is configured to transmit torque from pulley portion 66 and axial loads from end caps 64 to ball-nut 52. Thus, ball-nut 52 is rotated when motor 40 rotates shell assembly 62.

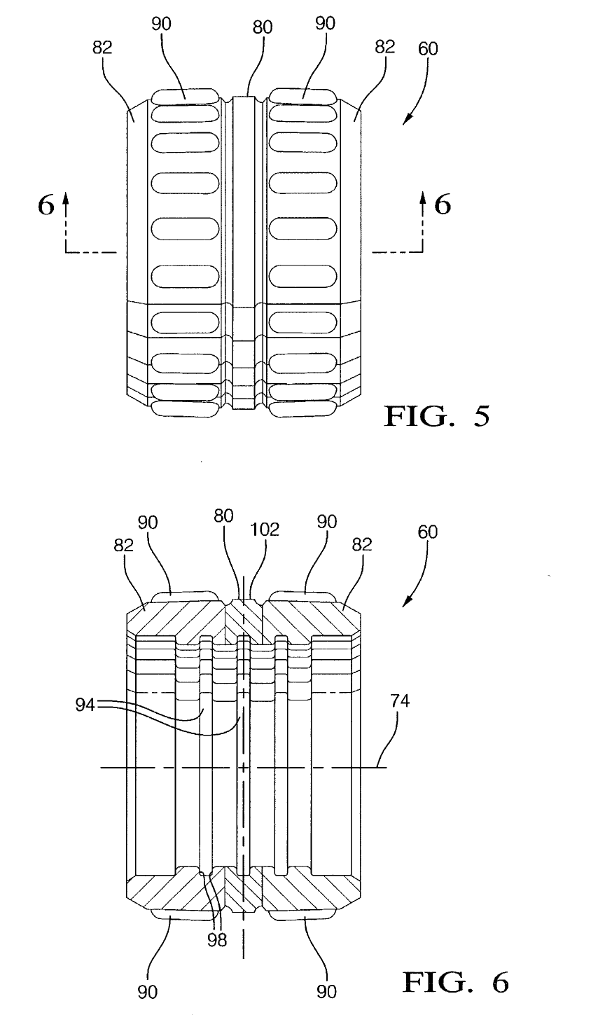

An exemplary embodiment of isolator member 60 is illustrated in FIGS. 4-6. Isolator member 60 comprises a center flange 80 and a pair of side portions 82. The side portions 82 are configured to transmit torque and axial loads from the pulley portion 66 and end caps 64 to the ball-nut 52. Specifically, isolator member 60 comprises an inner dimension 86 configured to engage an outer surface 88 of the ball-nut 52. Side portions 82 also comprise a plurality of protuberances 90 extending radially away from isolator member 60 such that protuberances 90 frictionally engage an inner surface 92 of pulley portion 66. In this manner, rotation of pulley portion 66 by belt 58 causes the ball-nut 52 to rotate. While it has been found that the disclosed design having a cylindrical cavity 76 is capable of transmitting significant torque from ball nut 52 to shell assembly 62, increased torque may be transmitted to shell assembly 62 by providing cavity 76 with internal flutes to engage protuberances 90, or by utilizing cooperating cross-sectional shapes as hexagonal, heptagonal, octagonal, decagonal, etc., with protuberances or other cooperating shapes engaging flutes, interior corners or flat interior surfaces or other similar structures.

Ball-screw assembly 54 is exposed to several adverse conditions during its normal use. Isolator assembly 60 is configured to counteract and mitigate many of these adverse conditions.

For example, isolator member 60 takes up bending moment stress that could otherwise be directed directly against ball nut 52. This affect will be described in further detail below. In addition, the interaction of ball-nut 52 and threaded ball-screw portion 50 during the movement of rack shaft 26 can cause noise and vibration to emit from ball-screw assembly 54. Isolator member 60 is adapted to absorb at least a portion of the noise and vibration, and to mitigate their transmission to pulley portion 66. Specifically, the material properties of isolator member 60 can be chosen to mitigate the transmission of vibration and noise in ball-screw assembly 54 to pulley portion 66. This can result in a less noisy ball-screw assembly 54 than previously available. Additionally, the reduction in vibration that is transmitted to belt 58 can increase the life of the belt.

In one embodiment, center flange 80 is made from a first plastic material, while side portions 82 is made from a second, more elastic, plastic material. For example, the first plastic material can be nylon 66 having a Shore A durometer of at least about 80, e.g., about 120, while the second plastic material can be nitrile rubber (NBR) having a Shore A durometer of from about 30 to about 90, e.g., about 60. The properties of the materials of isolator member 60 alleviates over constraint of the ball-screw assembly and reduces the transmission of vibration and noise from the assembly, as will be further described below. In another embodiment, center flange 80 is formed of a non-elastomeric material, such as a metal, e.g., steel.

In an exemplary embodiment, isolator member 60 and ball-nut 52 are mechanically engaged to one-another via interlocking structures. In one embodiment, such interlocking structures comprise one or more grooves 94 (FIG. 6) extending radially toward axis 74. At least one groove 94 can be disposed in center flange 80. Grooves 94 are configured to engage a corresponding number of ridges 96 defined on the outer surface 88 of ball-nut 52. The engagement of grooves 94 and ridges 96 maintains ball-nut 52 in a desired axial position within shell assembly 62. In addition, the engagement of grooves 94 and ridges 96 form load bearing surfaces 98. Surfaces 98 transmit at least some of the axial forces from the ball-nut 52 to side portions 82 as compressive forces. The transmission of at least some of the forces on isolator member 60 as compressive forces can mitigate the degradation of the isolator member that may occur over repeated use of the assembly due to shear forces that would be present absent surfaces 98. Surface 105 of side portion 82 transmits axial force to surface 106 of end cap 64.

In an alternate embodiment, isolator member 60 and ball-nut 52 are bonded to each other without aid of interlocking structures as described above. Chemical bonding of the two materials may be carried out in any known manner, including direct bonding, or through the use of a bonding agent or adhesive. Of course, both chemical and mechanical engagement means may be used to provide enhanced connection.

The rigid properties of center flange 80 assist in spreading the compressive forces from surfaces 98 across the entire diameter of side portions 92. The material properties of isolator member 60 also aid in maintaining ball-nut 52 centered axially and radially within shell assembly 62. Namely, center flange 80 ensures that ball-nut 52 rotates concentrically within pulley assembly 66.

Isolator member 60 may be manufactured in any convenient manner. For example, the isolator member 60 can be formed in two or more semi-cylindrical portions. The portions are placed around ball-nut 52 so that grooves 94 and ridges 96 are engaged in the desired manner. Next, pulley portion 66 is pressed over isolator assembly 60 in a direction along arrow 34. Finally, end caps 64 are secured to pulley portion 66. Pulley portion 66 and end caps 64 can be secured to one another by any suitable connection means. For example, inner surface 92 can have an inner diameter that forms a clearance fit with a diameter of a shoulder 104 formed on end caps 64. Of course other connection means, such as, but not limited to, mechanical means (e.g., bolts, clips, and others), adhesive means (e.g., glues, and the like), and welds.

Alternatively, isolator member 60 may be injection molded in place around ball-nut 52. For example, center flange 98 may be formed by a clam-shell mold extending around and sealed to ball-nut 52, and injection-molding center flange 98. Once center flange 80 is formed, the mold is removed, and second and third mold spaces are provided by a second clam-shell mold for the two side portions 92 in which the second plastic material is injection-molded. Thus, a positive and adhesive bond may be formed between isolator member 60 and ball-nut 52. Use of adhesives, welding, molding or other bonding techniques may eliminate the necessity for interlocking structures as described above.

It should be recognized that isolator member 60 is described above by way of example only as including engaged grooves and ridges as the means for converting the shear forces on the isolator member into compressive forces on the side portions. Of course, any means or interlocking structures for converting the shear forces on the isolator member into compressive forces are contemplated for use with the present disclosure. For example, isolator member 60 may be threadingly engaged over ball-nut 52, the thread walls serving as surfaces 98.

It should also be recognized that the shear forces can also be applied between protuberances 90 and inner surface 92. Center flange 80 can be configured to convert these shear forces into compressive forces on the side portions 82 through means such as, but not limited to, the use of ribs on the exterior of the isolator member 60 and corresponding lips in the inner surface 92 of pulley portion 66.

During the normal use of the vehicle, road wheels 12 are exposed to various forces and impacts. These forces and impacts can be transmitted through the articulated mechanical linkage to rack shaft 26, and to ball-screw assembly 54.

In some prior art systems, the ball-nut is rigidly mounted in the vehicle. However, providing such a rigidly mounted ball-nut causes the steering system to be over constrained, thereby resulting in high friction and excessive wear and tear in the ball-screw assembly. Such systems can show high friction and wear at the ball-nut, which is an indication that the rack is angularly misaligned, thereby causing strain on the system. This implies that some prior art ball-screw assemblies are over constrained.

Isolator member 60 is further configured to provide a means to relieve the over constrained condition. Specifically, isolator member 60 provides a degree of freedom to ball-screw assembly 54 that can relieve the over constrained condition by permitting pivotal movement of ball-nut 52 about a point 100 (FIG. 4) on the axis 74 of the shaft.

For example, center flange 80 abuts inner surface 92 of pulley portion 66 at a pivot surface 102. Pivot surface 102 can act as a fulcrum about which isolator member 60 can pivot. Specifically, center flange 80 is harder and more rigid than side portions 82 (e.g., resists compression under radial load) and the side portions are softer and can flex. Thus, the forces on rack shaft 26 can cause ball-nut 52 to pivot with center flange 80 at pivot surface 102 by compressing side portions 82. Upon the removal of the forces on the rack shaft, the elastic nature of isolator member 60 biases ball-nut 52 to its normal, un-pivoted position. Thus, ball-screw assembly 54 having isolator member 60 acts as a spherical joint that allows ball-nut 52 and rack shaft 26 to pivot about point 100 (FIG. 4), without causing shell assembly 62 to move. Since support surfaces 68 and recess 72 are not moved by the movement of ball-nut 52 and rack shaft 26, less stress is placed on belt 58 and bearings 70. This can further increase the life span of these components.

Generally, the range of movement of ball-nut 52 in relation to shell assembly 62 is from about 0 to about 10 degrees. Alternatively, the range may extend only to about 2.5 degrees. In any case sufficient freedom of movement should be allowed to solve the over constrained condition while providing the ball-screw assembly 54 with acceptable load carrying capability.

Accordingly, isolator member 60 is adapted to counteract and mitigate many of adverse conditions to which ball-screw assembly 54 is exposed. This allows ball-screw assembly 54 to be quieter, more robust, and have a longer life span than prior assemblies.

In addition, it has been determined that the use of isolator member 60 in ball-screw assembly 54 allows the tolerances between threaded portion 50 and ball-nut 52 to be increased. Specifically, prior ball-screw assemblies have required that the tolerances in these components be held to a tight limit, which typically resulted in the assemblies being formed by precise, expensive and time consuming processes, such as grinding. However, isolator member 60 allows the tolerances on ball-screw assembly 54 to be increased to the point where less precise and expensive processes, such as machining, e.g., using a lathe, can be used. This allows ball-screw assembly 54 to be less expensive than prior assemblies.

It should also be noted that the terms “first”, “second”, and “third” may be used herein to modify elements performing similar and/or analogous functions. These modifiers do not imply a spatial, sequential, or hierarchical order to the modified elements, unless otherwise indicated.

While the invention has been described with reference to one or more an exemplary embodiments, it will be understood by those skilled in the art that various changes may be made and equivalents may be substituted for elements thereof without departing from the scope of the invention. For example, isolator member 60 may be splined to ball nut 52 and axial loads may be passed by ball nut 52 bearing directly upon side portions 82 or otherwise engaging shell assembly 62. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A ball-screw assembly, comprising:
a ball-nut threadably engaged with a ball-screw such that rotation of said ball-nut causes said ball-screw to move in a linear direction;
a shell assembly defining a cavity, said ball-nut being disposed in said cavity; and
an isolator member formed of a first and second material of differing hardness being disposed between said shell assembly and said ball-nut, said isolator member being configured to transmit rotational forces between said shell assembly and said ball-nut, said isolator member acting as a spherical joint to allow said ball-nut and said ball screw to pivot within said shell assembly about a point on an axis of said ball screw, without causing said shell assembly to move.

2. The ball-screw assembly as in claim 1, wherein said ball-nut is pivotable from 0 to about 2.5 degrees from an axis of said shell assembly.

3. The ball-screw assembly as in claim 1, wherein said isolator member comprises a center flange formed of said first material and a pair of side portions formed of said second material, said center flange being fixed to said ball nut.

4. The ball-screw assembly as in claim 3, wherein said center flange abuts an inner surface of said shell assembly at a pivot surface, said pivot surface acting as a fulcrum about which said isolator member pivots by compressing said side portions.

5. The ball-screw assembly as in claim 4, wherein said side portions bias said ball-nut to a normal, un-pivoted position such that said ball nut is coaxially positioned within said shell assembly.

6. The ball-screw assembly as in claim 5, wherein said first material is plastic, and said second material is also plastic, said first material being more rigid than said second material.

7. The ball-screw assembly as in claim 6, wherein said first material has a Shore A durometer of at least about 80 and said second material has a Shore A durometer of from about 30 to about 90.

8. The ball screw assembly as in claim 7, wherein said first material has a Shore A durometer of about 120 and said second material has a Shore A durometer of about 60.

9. The ball-screw assembly as in claim 6, wherein said isolator member mitigates transmission of vibration and noise from said ball-nut to said shell assembly.

10. The ball-screw assembly of claim 3 wherein said first material is harder than said second material.

11. The ball-screw assembly as in claim 1, further comprising a plurality of protuberances extending from said isolator member, said plurality of protuberances frictionally engaging an inner surface of said shell assembly.

12. The ball-screw assembly as in claim 11, wherein said cavity is substantially cylindrical.

13. The ball-screw assembly as in claim 1, wherein said isolator member comprises a center flange fixed to said ball nut to transmit axial forces of said ball-nut to said isolator member as compressive forces.

14. The ball-screw assembly as in claim 13, wherein said means for transmitting axial forces is further configured to maintain said ball-nut in a desired axial position within said shell assembly.

15. The ball-screw assembly as in claim 13, wherein said means for transmitting comprises interlocking structures on in an inner surface of isolator member and on an outer surface of said ball-nut, said interlocking structures forming a load bearing surface for transmitting said axial forces to said isolator member as said compressive forces.

16. The ball-screw assembly as in claim 15, wherein said center flange is sufficiently rigid to distribute said compressive forces across substantially all of said side portions.

17. A steering system for a vehicle, comprising:
a steering input device;
a sensor for detecting a condition of said steering input device, said sensor generating a first signal indicative of said condition;
a controller receiving said first signal and generating a second signal in response to at least said first signal;
a motor being controlled by said second signal from said controller, said motor being configured to apply a rotational force to a shell assembly of a ball-screw assembly, said shell assembly being supported in said vehicle so as to be rotatable about a first axis;
an isolator member formed of first and second materials of differing hardness being disposed between an inner surface of said shell assembly and an outer surface of a ball-nut threadably engaged with a rack shaft, said isolator member being configured to transmit said rotational force from said shell assembly to said ball-nut to cause said rack shaft to move in a linear direction along said first axis, said rack shaft being operatively engaged with a steering output device such that movement in said linear direction changes a position of said steering output device, wherein said isolator member acts as a spherical joint that allows said ball-nut and said rack shaft to pivot about point on said first axis with respect to said shell assembly.

18. The steering system as in claim 17, wherein said ball-nut is pivotable in relation to said shell assembly from 0 to about 10 degrees.

19. The steering system as in claim 17, wherein said steering input device is a hand wheel and said steering output device is a steerable road wheel.

20. The steering system as in claim 19, wherein the steering system is one of an electrically assisted steering system and an electrically actuated steering system.

21. The steering system as in claim 20, wherein said motor drives a belt or a chain to apply said rotational force to said exterior of said pulley portion.

22. The steering system as in claim 17, wherein said shell assembly comprises a pulley portion and a pair of end caps, said shell assembly being rotatably supported in said vehicle by a bearing disposed at each of said end caps, and said rotational force being applied to said shell assembly at said pulley portion.

23. The steering system as in claim 17, wherein said isolator member comprises a center flange formed from said first material and a pair of side portions formed from said second material.

24. The steering system as in claim 23, further comprising a plurality of protuberances extending from said isolator member, said plurality of protuberances frictionally engaging said inner surface of said shell assembly.

25. The steering system as in claim 23, wherein said first material is plastic, and said second material is plastic, said first material being more rigid than said second material.

26. The steering system as in claim 23, wherein said first material has a Shore A durometer of from about 80 to about 160 and said second material has a Shore A durometer of from about 30 to about 90.

27. The steering system as in claim 17, wherein said isolator member mitigates transmission of vibration and noise from said ball-nut to said shell assembly.

28. The steering system as in claim 23, wherein said center flange ensures that said ball-nut rotates concentrically within said shell assembly.

29. The steering system as in claim 17, wherein said isolator member comprises means for transmitting axial forces of said ball-nut to said isolator member as compressive forces.

30. The steering system as in claim 29, wherein said means for transmitting axial forces is further configured to maintain said ball-nut in a desired axial position within said shell assembly.

31. The steering system as in claim 29, wherein said transmitting means comprises interlocking structures on an inner surface of said isolator member and on an outer surface of said ball-nut, said interlocking structures forming a load bearing surface for transmitting said axial forces to said isolator member as compressive forces.

32. The steering system as in claim 31, wherein said isolator member comprises a center flange formed of said first material, which is plastic, and a pair of side portions formed of said second material, which is also plastic, the first material being more rigid than said second material.

33. The steering system as in claim 32, wherein said interlocking structures are formed at least in part on said center flange such that said center flange distributes said compressive forces across substantially all of said side portions.

34. The steering system as in claim 32, wherein said center flange ensures that said ball-nut rotates concentric within said shell assembly.

35. The steering system as in claim 23, wherein said center flange abuts said inner surface of said pulley portion at a pivot surface, said pivot surface acting as a fulcrum about which said isolator member pivots by compressing said side portions.

36. The steering system as in claim 35, wherein said side portions biases said ball-nut toward a normal, un-pivoted position with respect to said shell assembly.
